(19) United States
(12) Patent Application Publication
(10) Pub. No.: US 2003/0034343 A1
(43) Pub. Date: Feb. 20, 2003

(54) Glow plugs and a method of producing glow plugs

(75) Inventor: Paul Keller, Bietigheim (DE)

Correspondence Address: NIXON PEABODY, LLP, 8180 GREENSBORO DRIVE, SUITE 800, MCLEAN, VA, 22102, US

(73) Assignee: BERU AG, Ludwigsburg (DE)

(21) Appl. No.: 10/200,591

(22) Filed: Jul. 23, 2002

(30) Foreign Application Priority Data
Jul. 23, 2001 (DE) 10134956.4

(51) Int. Cl. H05B 1/02

(52) U.S. Cl. 219/500

(57) ABSTRACT

A method of producing a glow plug including a glow tube (5) with internal heating coil (4) and optionally regulating coils which are embedded therein using a ceramic filling, whereby a compaction of an area on a combustion chamber side of the glow tube (5) is performed using a recessing-reducing process with a radial feed.

### BACKGROUND OF THE INVENTION

1. Field of the Invention

The invention relates to glow plugs and a method for the production of glow plugs.

2. Description of the Related Art

As shown in FIGS. 1, 2(a) & 2(b), a conventional glow plug has a glow tube 5 without additional tapering and without additional compaction of the glow rod tip. The glow tube 5 has an internal heating coil 4 which is embedded therein using a ceramic filling 3. At the tip of glow tube 5 on the combustion chamber side, the heating coil 4 is connected with the glow tube 5 by welding 6. At the opposite end of the glow tube 5, the heating coil 4 is connected with a connection pole 1. The front area 5a on the combustion chamber side of glow tube 5 is reduced cylindrically according to the known feed method.

As shown in FIGS. 3(a) & 3(b), in order to improve the compaction in the area of the combustion chamber side of the glow tube, the area 5a above the tip of the glow tube 5 is reduced from diameter D1 to diameter D2. In particular, at the glow tube tip 5a, the area is reduced using a so-called feed process whereby either continuous cylinders or a linear taper towards the tip of the heating rod are obtained. With this process, the glow rod is inserted into a swaging tool having a lead-in inclined area whereby the diameter is reduced by the swaging process and the axial feed of the glow tube.

The reduction in diameter that results in using the feed process, however, leads to unsatisfactory compaction precisely in the critical area directly behind the welding of the heating coil and the glow tube tip. Equally, there is little opportunity for more complex shapes of the glow tube area on the combustion chamber side, which influence glow behavior, glow distribution and the life of the glow plugs, or expansion of new possibilities for glow plug applications.

### SUMMARY OF THE INVENTION

An object of the invention is to enhance the compaction in the glow tube tip while avoiding the disadvantages of the related art. In this regard, a new shaping of the tip area of the glow tube expands new possibilities for applications, in particular, the possibility of fitting other components.

The object of the invention may be achieved using a method for producing glow plugs having an internal heating coil and optionally regulating coils that are embedded in an annular space of the glow using a ceramic filling, whereby a compaction of the area on the combustion chamber side of the glow tube is performed using a recessing-reducing process with an radial feed. The recessing-reducing process is performed using a recessing tool having a pair of tool elements or stamps with stamping faces that have several zones that are arranged at an angle relative to one another. Alternatively, the stamping faces may be curved in a convex and/or concave manner. Moreover, the area on the combustion chamber side of the glow tube has band-shaped or groove-shaped neck.

Accordingly, the method and apparatus in accordance with the invention are advantageous since they result in a compaction or deformation by way of the recessing-reducing process whereby the glow tube is positioned in the recessing tool so that the stamps act radially on the glow tube and compact the glow tube to the desired diameter. As a result, a more uniform compaction occurs since an axial feed does not take place in this compaction phase so that in the presence of a solely radial action of the tool stamps, the material and coil of the glow tube are not axially displaced.

### BRIEF DESCRIPTION OF THE DRAWINGS

FIG. 1 shows in a longitudinal section, a glow tube of a glow plug from the prior art;

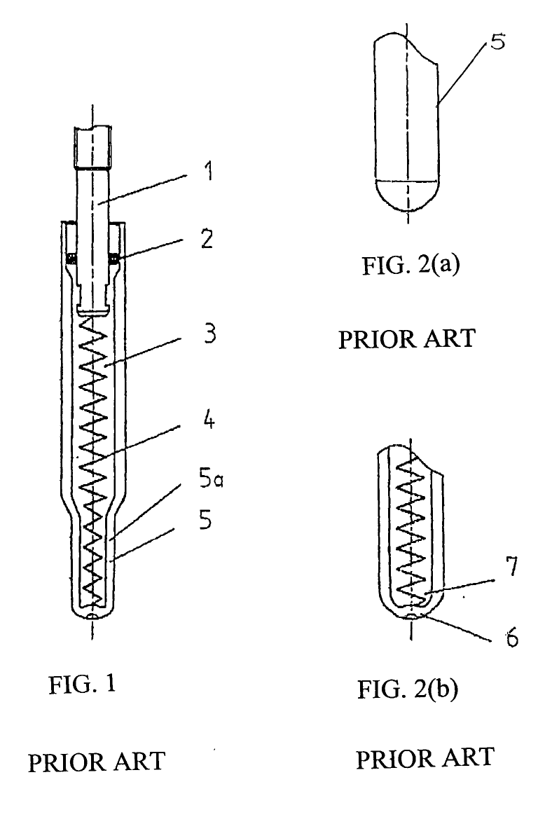

FIGS. 2(a) & 2(b) show side and cross-sectional views, respectively, of the tip area of a conventional glow tube of FIG. 1 without additional tapering or compaction;

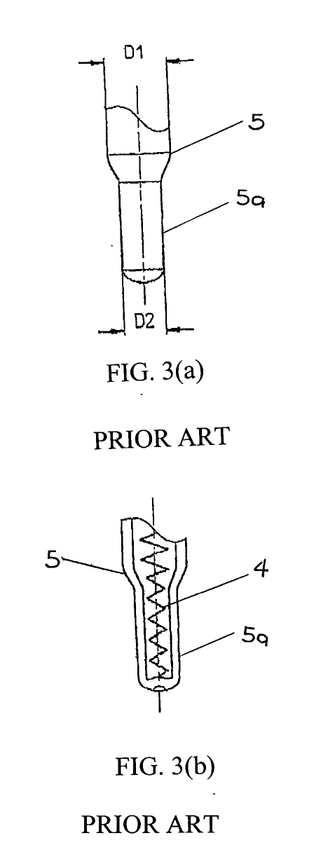

FIGS. 3(a) & 3(b) show side and cross-sectional views, respectively, of a prior art glow rod with additional tapering of the glow rod tip;

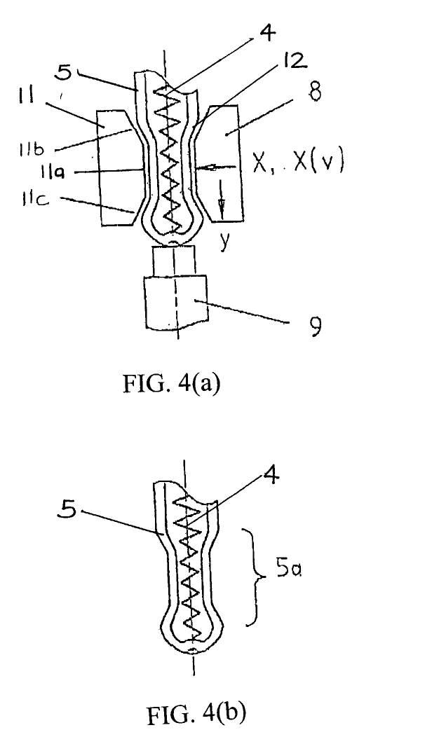

FIGS. 4(a-d) show a longitudinal section of the area on the combustion chamber side of a glow plug deformed or compacted according to the invention with tools for recess-kneading and another embodiment of a glow rod tip with additional tapering using a recess-kneading process; and

FIGS. 5(a) and 5(b) show another embodiment of a glow rod tip having additional tapering using a recess-kneading process by way of a tool having various radii of the stamp faces.

### DETAILED DESCRIPTION OF THE INVENTION

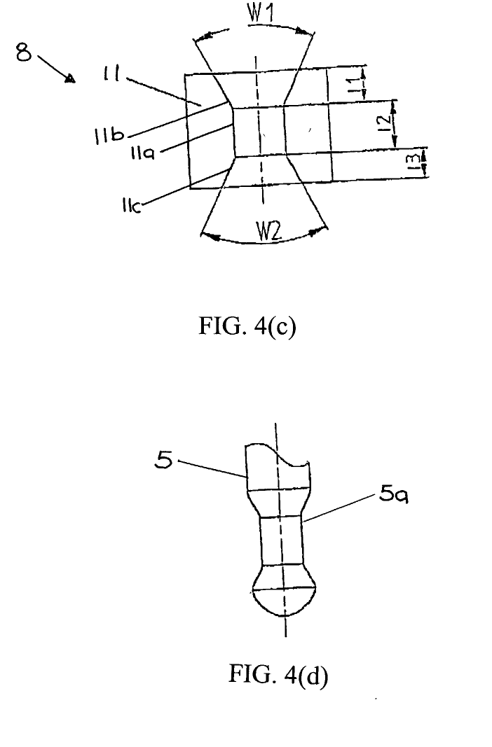

FIGS. 4(a-d) show a method in accordance with the invention whereby a glow tube 5 having a tip area 5a that is deformed on the combustion chamber side of glow tube 5. Located above the tip 5a area is a band-shaped neck 12. The tip 5a area is particularly heavily compacted and leads, due to the proximity of the glow tube wall to the heating coil 4, to the band-shaped neck 11 of particularly rapid heating when current flows through the heating coil 4.

In FIG. 4(a), the production process of the glow plug shown in FIG. 4(b) is performed using a recessing-reducing process that includes a recessing device (not shown) having a recessing tool 8. The recessing tool 8 has a tool stamp 11 having three stamp faces 11a-c which act on the wall of the glow tube 5. The stamp faces include a base face 11a and secondary stamping faces 11b and 11c that are set at an angle relative to the base stamp face 11a. As shown in FIG. 4(c) the stamp faces 11a-c of the recessing tool 8 have differing lengths (11, 12, 13), whereby W1 and W2 indicate the angles of the front faces with respect to the recessing direction.

The recessing tool 8 oscillates with a small stroke in direction X as in the feed process, but without any axial feed. A radial feed movement (X(v)) is superimposed on this movement whereby the diameter of the glow tube 5 at the area of the glow tube tip 5a is further reduced with each stroke. In this way, the area of the glow tube 5a is deformed according to the orientation of stamp faces 11a-c of the recessing tool 8. An anvil 9 prevents the material giving way in the area of the glow tube tip 5a. Here, the tool is beveled or rounded off in the edge areas in order to permit a certain movement of the material. Finally, the pure recessing process can be carried out in combination with the feed process, whereby the axial feed of the worked work-piece takes place in the direction indicated by the arrow. FIG. 4(d) shows a glow tube tip 5a deformed in accordance with the method of the invention described hereinabove.

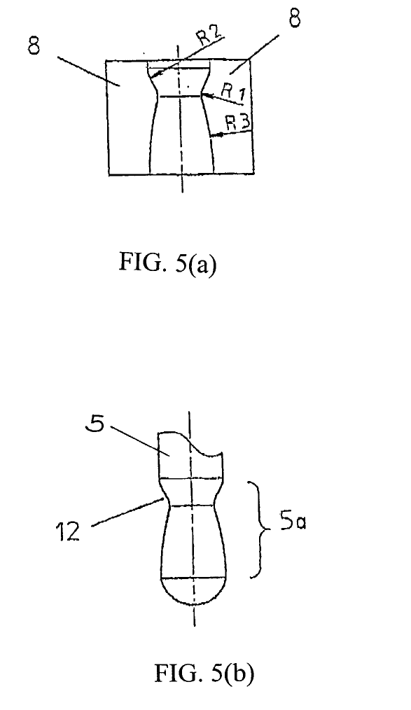

FIG. 5(b) shows another embodiment of a glow tube 5 having an area at the tip end 5a thereof on the combustion chamber side of a glow tube 5. The glow tube 5 has a groove-shaped neck portion 12 above the glow tube tip end of the glow tube 5 that is produced using the previously described recessing-reducing process. In particular, the area 5a lies between a tip end of the glow tube 5 and a main portion of the glow tube 5. The recessing tool 8 used to perform this process has differently curved stamp faces 11 of differing radii R₁, R₂ and R₃ as shown in FIG. 5(a).

What is claimed is:

1. A method of producing a glow plug including a glow tube with an internal heating coil which is embedded therein using a ceramic filling, said method comprising the step of:
compacting an area on a combustion chamber side of the glow tube using a recessing-reducing process having a radial feed of the glow tube.

2. The method according to claim 1, wherein the recessing-reducing process is performed using a recessing tool having a tool stamp with a plurality of stamp faces which act on a wall of the glow tube.

3. The method according to claim 2, wherein the stamp faces comprise a base stamp face and a pair of secondary stamp faces that are set at an angle relative to the base stamp face.

4. The method according to claim 2, wherein the plurality of stamp faces are curved in at least one of a convex and concave manner.

5. A glow plug comprising:
a glow tube with an internal heating coil which is embedded in the glow tube using a ceramic filling,
wherein the glow tube includes an area on a combustion chamber side thereof that has a band-shaped or groove-shaped neck portion, said area lying between a tip end of the glow tube and a main portion of the glow tube.

6. A glow plug according to claim 5, wherein said neck portion comprises a cylindrical surface of reduced diameter relative to the main portion and tip end of the glow tube and bevel-shaped sloping surfaces extending between the cylindrical surface and the main portion and tip end of the glow tube.

7. A glow plug according to claim 5, wherein said neck portion comprises a groove with differently curved faces of differing radii.
